(19) United States
(12) Patent Application Publication
(10) Pub. No.: US 2006/0198862 A1
(43) Pub. Date: Sep. 7, 2006

(54) Snail baiting agent

(76) Inventors: Wolfgang Wirth, Monheim (DE); Gerhard Baron, Leverkusen (DE); Michael Kilian, Leverkusen (DE); Udo Reckmann, Monheim (DE)

Correspondence Address: BAYER CROPSCIENCE LP;Patent Department, 100 BAYER ROAD, PITTSBURGH, PA, 15205-9741, US

(21) Appl. No.: 10/546,767

(22) PCT Filed: Feb. 13, 2004
(86) PCT No.: PCT/EP04/01421

§ 371 Date: Jan. 18, 2006

(30) Foreign Application Priority Data
Feb. 26, 2003 (DE) 103-08.108.9

(51) Int. Cl. A01N 59/26; A01N 25/08

(52) U.S. Cl. 424/410; 424/601

(57) ABSTRACT

This invention relates to compositions containing (1) either
a) a phosphonic acid ester of the formula (I) 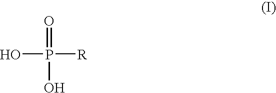
in which R stands for C₁-C₁₀ alkyl, which is equally or differently substituted once or several times by PO₃H₂, OH, NH₂, CN, halogen, C₁-C₈ alkylamine or C₂-C₁₆ dialkylamine and is optionally interrupted by 1-6 heteroatoms from the series N, O, S, P, wherein heteroatoms are not directly coupled to one another; and contain ammonium-, alkaline metal-, alkaline-earth metal- and/or iron salts; or b) ammonium-, alkaline metal-, alkaline-earth metal and/or iron salts of the phosphonic acid esters of the formula (I) and (2) fine-grained cereal flour, (3) an optional binding agent and (4) optionally one or more additives; to a method for the manufacture of these compounds and to their use for the control of terrestrial snails.

The present invention concerns a snail baiting agent based on phosphonic acid esters, a method for its manufacture and its use for the control of snails.

It is already known that terrestrial snails can be controlled with the assistance of baiting agents that contain frass materials and molluscicidal active substances such as methiocarb, metaldehyde or metal chelates (compare DE 35 03 608A, DE 36 12 161A, WO 96-05 728A, WO 97-26 789A, WO 99-25 194A, WO 99-39 576A and WO 00-11 948A). The effectiveness of these preparations, however, is not always satisfactory.

There are now new snail baiting agents found that contain
1. a) phosphonic acid ester of the formula (I) 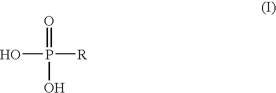
   in which R stands for C₁-C₁₀ alkyl,
   which is equally or differently substituted once or several times by means of PO₃H₂, CO₂H, OH, NH₂, CN, halogen, C₁-C₈ alkylamine or C₂-C₁₆ dialkylamine, and
   which is optionally interrupted by 1-6 heteroatoms from the series N, O, S, P, wherein heteroatoms are not directly coupled to one another;
   and contain
   amonium-, alkaline metal-, alkaline-earth metal- and/or iron salts; or
   b) ammonium-, alkaline metal-, alkaline-earth metal and/or iron salts of the phosphonic acid esters of the formula (I) and
2. fine-grained cereal flour,
3. optional binding agent and
4. optionally one or more additives

Furthermore, it was found that the new snail baiting agents can be manufactured by producing
1. a premix out of
   phosphonic acid ester of the formula (I) 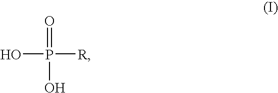
   and ammonium-, alkaline metal-, alkaline-earth metal- and/or iron salts, or
   ammonium-, alkaline metal-, alkaline-earth metal and/or iron salts of the phosphonic acid esters of the formula (I)
   at least one diluent and
   optional additives,
2. mixing the premix thus obtained with
   fine-grained cereal flour,
   optional binding agent and
   optional additives,
3. if necessary, stirring the resulting mixture with an amount of water such that a homogeneous dough results,
4. extruding the dough and reducing it to small pieces and
5. drying the accumulated product.

Finally, it was found that the new snail baiting agents are very useful for the control of terrestrial snails.

Surprisingly, the baiting agents according to the invention exhibit decidedly better effectiveness for the control of snails than the constitutionally-similar preparations already known for the same purpose.

The snail baiting agents according to the invention are characterised by the listed component parts.

The active components that are contained in the snail baiting agents according to the invention involve either
a) one or several ammomium-, alkaline metal-, alkaline-earth metal and/or iron salts of the phosphonic acid esters of the formula (I) or
b) one or several ammonium-, alkaline metal-, alkaline-earth metal and/or iron salts of the phosphonic acid esters of the formula (1) in mixture with one or several magnesium-, calcium- and/or iron salts or
c) phosphonic acid ester of the formula (1) in mixture with one or several magnesium-calcium- and/or iron salts.

Preferred are phosphonic acid esters of the formula (Ia) 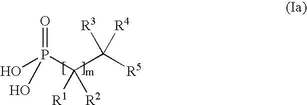
in which
R¹, R², R³, R⁴ and R⁵ stand independent of one another respectively for hydrogen, C₁-C₄ alkyl, CO₂H, CH₂CO₂H, PO₃H₂, OH, halogen, CN, NH₂ and
m stands for the numbers 0, 1, 25 3, 4 or 5.
R¹, R², R³, R⁴ and R⁵ preferably stand independently of one another respectively for hydrogen, methyl, ethyl, n-propyl, iso-propyl, n-butyl, iso-butyl, sec-butyl, tert-butyl, PO₃H₂, CO₂H, CH₂CO₂H, OH.
m preferably stands for the numbers 0, 1 or 2.

Likewise preferred are phosphonic acid esters of the formula (Ib) 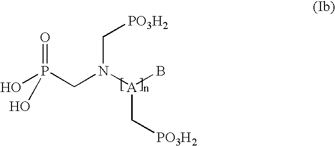
in which
A stands for C₁-C₆ alkyl, C₁-C₆ alkylamino, C₁-C₆ alkoxy, whereby two heteroatoms are not directly bound to one another,
B stands for H, OH, CH₂PO₃H₂, CN, halogen, NH₂, C₁-C₈ alkylamine or C₂-C₁₆ dialkylamine,
n stands for the numbers 0, 1, 2, 3, 4.
A preferably stands for the following groupings: 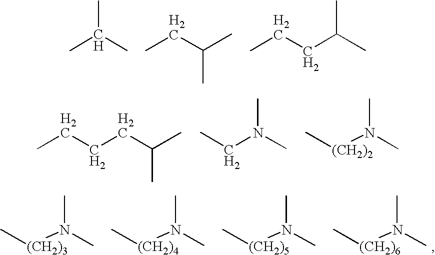
   whereby the carbon atom shown on the left is bound to the nitrogen in formula (Ib).
B preferably stands for H, OH or CH₂PO₃H₂.
n preferably stands for the numbers 0, 1 or 2.

These rest definitions can be arbitrarily combined one below the other and also between the specified areas. Likewise, individual definitions can be omitted. According to the invention, preferred are the compounds of the formula (I) in which a combination of the preferred meanings listed above is available. The rest definitions listed above generally or in preferred areas apply for the end products of the formula (I) as well as correspondingly for the respective starting- or intermediate products required for manufacture.

Especially preferred are the compounds of the formula (I-1)

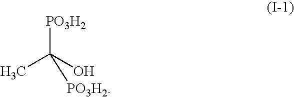

Likewise especially preferred are the compounds of the formula (I-2)

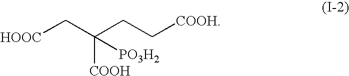

Likewise especially preferred are the compounds of the formula (I-3)

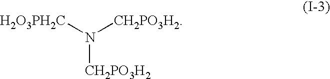

Likewise especially preferred are the compounds of the formula (I-4)

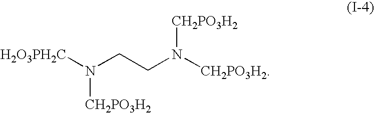

Likewise especially preferred are the compounds of the formula (I-5)

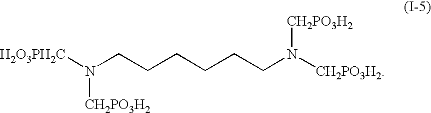

Likewise especially preferred are the compounds of the formula (I-6)

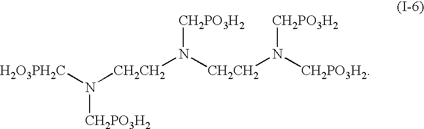

Likewise especially preferred are the compounds of the formula (I-7)

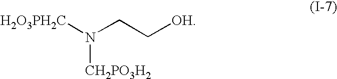

The ammonium-, lithium-, sodium-, potassium-, magnesium-, calcium-, iron(II)- and iron(III) salts are especially qualified as salts of the phosphonic acid esters. These salts can involve standard or mixed salts. Standard salts are to be understood here as those salts that contain only one of the mentioned cations. Mixed salts are to be understood here as those salts that contain several of the mentioned cations. In addition, also coming into consideration are those salts in which not all H₂O₃P groups of the phosphonic acid esters exist in salt form.

The phosphonic acid esters of the formula (I) and their salts are known or can be manufactured according to known methods.

Alongside the phosphonic acid esters of the formula (I) or their salts, one or several magnesium-, calcium- and/or iron salts can also be contained in the snail baiting agents according to the invention.

Sulfates, carbonates and phosphates preferably come into consideration as salts of the mentioned metals. Exemplarily mentioned are magnesium sulfate, magnesium carbonate, calcium sulfate, calcium carbonate, iron(II) sulfate, iron(III) sulfate, iron(II) hydrogen sulfate, iron(III) hydrogen sulfate, iron(II) hydrogen phosphate, iron(III) hydrogen phosphate, iron(II) hydrogen carbonate, iron(II) phosphate, iron(III) phosphate, iron(II) carbonate and iron(III) carbonate. The salts can exist as hydrates or in anhydrous form. Especially preferred are iron(II) phosphate, iron(III) phosphate, iron(II) hydrogen phosphate, iron(III) hydrogen phosphate, iron(II) dihydrogen phosphate and iron(III) dihydrogen phosphate,

Commercially-available flours such as wheat flour, rye flour, rice starch and others can be included as cereal flours in the snail baiting agents according to the invention. Durum wheat flour and soft wheat flour are preferred. The flour is available in fine-grained form, preferably in grain sizes below 250μ.

All glutens ordinarily useful for the manufacture of preparations of this type can be included as binding agents. Modified starches, substances separated from formaldehyde, and if necessary, partially-saponified polyvinyl acetate and/or molasses come into particular consideration.

In the present case, modified starches are to be understood as commercially-available products of this type. Pregelatinised corn starch is preferred.

All ordinary products that are suitable for the release from formaldehyde can be included as substances separated from formaldehyde. Urea-formaldehyde condensation products are preferred.

The products known under the trade names Mowilith® (Clariant company) and Mowiol® (Clariant company) are especially suitable as polyvinyl acetates, which can be included in partially-saponified form if necessary.

In the present case, molasses is to be understood as the syrupy mother liquor created during the manufacture of sugar.

Preservatives, dyestuffs, snail attractants, grinding additives, additives, bitters, endotherm repellents, and anti-caking agents as well as water and other molluscicidal active substances come into particular consideration as additives that can be included in the baiting agents according to the invention.

All substances customarily suitable for this purpose come into consideration as preservatives. Preferably mentioned are 2-hydroxybiphenyl, sorbic acid, p-hydroxy benzaldehyde, p-hydroxy benzoic acid methyl ester, benzaldehyde, benzoic acid, p-hydroxy benzoic acid propyl ester and p-nitrophenol.

All substances customarily suitable for this purpose come into consideration as dyestuffs. Preferably mentioned are inorganic pigments such as iron oxide, titanium dioxide und ferrocyan blue, as well as organic dyestuffs such as anthraquinone-, azo- and metal phthalo blue dyestuffs.

All substances customarily suitable for this purpose come into consideration as snail attractants. Exemplarily mentioned are plant extracts and their derivatives, as well as products of animal origin.

All substances customarily suitable for this purpose come into consideration as grinding additives. Exemplarily mentioned are kaolinites, alumina, talcum, chalk, quartz powder and highly dispersed silicon dioxide.

Substances that are suitable for the adjustment of the pH-value in the baiting-agent preparations come into consideration as additives. Exemplarily mentioned is citric acid.

All substances customarily suitable for this purpose come into consideration as bitters. Exemplarily mentioned is denatonium benzoate.

All substances that exert a repellent effect on warm-blooded creatures such as dogs or hedgehogs that are customarily suitable for this purpose come into consideration as endotherm repellents. Exemplarily mentioned is nonylic acid vanillylamide.

All substances that inhibit clumping and sticking that are customarily suitable for this purpose come into consideration as anti-caking agents. Exemplarily mentioned are moisture-adsorbent powders such as diatomaceous earth, pyrogenic silicon dioxide, tricalcium phosphate, calcium silicates, aluminium oxide, magnesium oxide, magnesium carbonate, zinc oxide, stearates and fat amines.

All substances customarily suitable for this purpose come into consideration as additional molluscicidal active substances. Exemplarily mentioned are methiocarb, metaldehyde as well as metal salts, if necessary in mixture with complexing agents, whereby chelates from ethylene diamine tetra acetic acid and iron- and/or copper ions are exemplarily mentioned.

The concentration of the individual components can be varied in the snail baiting agents within a designated range. Thus the concentrations are
in phosphonic acid esters of the formula (I) and/or their ammonium-, alkaline metal-, alkaline-earth metal and/or iron salts, optionally in mixture with one or several magnesium-, calcium- and/or iron salts, in general between 1.0 and 25% by weight, preferably between 5.0 and 20% by weight.
in cereal flour, in general between 50 and 95% by weight, preferably between 60 and 90% by weight,
in binding agents, in general between 0 and 20% by weight, preferably between 0 and 15% by weight,
in additives, in general between 0 and 5.0% by weight, preferably between 0 and 3.0% by weight.

Those components that were already mentioned as preferred component parts in connection with the description of the snail baiting agents according to the invention are preferably used for the implementation of the procedure according to the invention.

Inert organic solvents and/or water can be used as diluents during the implementation. Water is preferably used.

The amounts of the individual components are chosen such that the substances in the snail baiting agents according to the invention are present in those proportions by weight that were mentioned above. However, the amount of water or diluent is determined such that a dough develops in step (3) of the procedure. In general, the amount of water used lies between 25 and 35% by weight, preferably between 27 and 34% by weight, in terms of the remaining component parts. However, the concentration of water in the snail baiting agents according to the invention is definitely lower because the accumulated product that is initially moist in step (5) of the manufacturing procedure is still dried. As a practical matter, only the existing residual moisture in the cereal flour remains.

The temperatures can be varied within a designated range for the implementation of the method according to the invention. During the implementation, one works
at temperatures generally between 0° C. and 30° C., preferably at room temperature, for step (1),
at temperatures generally between 0° C. and 30° C., preferably at room temperature, preferably at room temperature, for step (2),
at temperatures generally between 0° C. and 40° C., preferably between 10° C. and 30° C., for step (3),
at temperatures generally between 20° C. and 60° C., preferably between 30° C. and 50° C., for step (4) and,
at temperatures generally between 20° C. and 90° C., preferably between 30° C. and 80° C., for step (5).

One generally works at atmospheric pressure during the implementation of steps (1) through (3) and (5) of the method according to the invention. However, it is also possible to implement the drying process in step (5) under diminished pressure. During the implementation of step (4), one generally works under elevated pressure, preferably under a pressure between 30 and 100 bar.

All traditional equipment for processes of this sort can be used for the implementation of the method according to the invention. Thus traditional mixers are suitable for the mixing procedures in steps (1) through (3) in which additional substances such as cereal flour, binding agents, diluents or water can be added during the mixing procedure. Plow mixers, paddle mixers and double-shaft extruders are preferably used.

Traditional equipment in the food industry comes into consideration for the extrusion in step (4), with whose assistance a dough can be pressed into strands through perforated discs and subsequently reduced to small pieces.

Traditional machines that are suitable for the removal of moisture from solid substance in the form of particles are suitable for drying the moist product in step (5). In a preferred implementation form, one works in such a way that he initially pre-dries the moist product in a fluidised bed and subsequently dries it in a separate device to the desired final moisture level.

In detail, one proceeds with the implementation of the method according to the invention such that one
manufactures a solution or suspension (“premix”) of phosphonic acid esters or their salts in step (1),
optionally in mixture with other of the mentioned metal salts, as well as diluents, preferably water and
optionally one or several additional molluscicidal active substances as well as optional additives such as, for example, preservatives, dyestuff, additives and so forth.
mixes the obtained premix with fine-grained cereal flour, optionally with binding agents and optionally with additional additives for a homogeneous product in step (2),
adds an amount of water while mixing and kneading such that a dough forms in step (3),
extrudes the dough under pressure and reduces it to small pieces in step (4) and
initially pre- and post dries and subsequently cools the material at room temperature in the form of particles in step (5).

In an alternative implementation form, powdered premixes can also be prepared in step (1) that are processed into a dough in step 2 with the phosphonic acid solution and the gluten solution.

In an alternative implementation form, step (3) can be omitted, especially if the dough already has the desired consistency.

In an alternative implementation form, the transition between pre- and post drying takes place continuously.

The quantity of the snail baiting agent can be varied within a designated range during the implementation of the method according to the invention in the respective desired ways. One generally reduces the dough to small pieces such that pellets or particles in the form of strands result. The average diameter and the average length of the particles generally lies between 1 and 4 mm, respectively, preferably between 1.5 and 3 mm.

The snail baiting agents according to the invention are quite well suited for the control of terrestrial snails in agriculture and in horticulture. Included in snails are all terrestrial slugs and snails with shells, the majority of which appear as polyphagous pests in agricultural and horticultural crops. Important pests of this type are snails such as Arion rufus (European red slug), Arion ater and other Arionidae, Limax species, other agricultural snails such as Deroceras reticulatum and agreste from the family Limacidae, as well as species from the family Milacidae, and also noxious snails with shells such as those of the genus Cepaea, Discus, Helicigona and Helicella.

The application amount of the baiting agent according to the invention can be varied within a large range for the control of snails. In general, one uses between 2 and 15 kg of snail baiting agent per hectare, preferably between 3 and 7 kg per hectare.

The snail baiting agents according to the invention can be deployed in accordance with traditional methods such as, for example, by means of scattering and drilling.

The invention is illustrated by means of the following examples.

### MANUFACTURING EXAMPLES

### Example 1

### Manufacture of Snail Baiting Agent According to the Invention

The powdered component parts are pre-mixed in a plow mixer. For this purpose, 9959 g of durum wheat flour with a grain size of under 250 μm and 392 g of iron(III) phosphate hydrate are homogenised for 5 minutes. The solid mixture is then transferred into a dough kneader.

660 g of a phosphonic acid of the formula (I-1) of approximately 60% concentration [HEDP; commercial product from the Zschimmer & Schwarz Mohsdorf company; pH 1] is diluted with 170 g of water and then slowly added to the dough kneader while stirring at room temperature. After the material is completely added it is mixed for 10 minutes.

2004 g of a polyvinyl acetate dispersion (Mowilith) with a concentration of approximately 60% is diluted with 170 g of water and then added likewise into the dough kneader while stirring. Here, as above, after the material is completely added it is stirred and kneaded for 10 minutes. The homogeneous dough that results is extruded at 40° C. under a pressure of 60 bar in the form of strands by means of a perforated disc with drilled holes having a diameter of 2.2 mm. Said strands are reduced with the assistance of rotary cutters into small cylindrical pieces of 2 to 3 mm in length. The accumulated material is dried for 30 minutes in a fluidised bed by means of an air stream whose temperature is continuously increased from 20° C. and whose discharged air reaches a temperature of 55° C. at the end of the drying process. After this, one lets the product cool to room temperature and keeps it open to the air for 3 days so that the pellets adjust to equilibrium moisture. In this way, one obtains approximately 12,000 g of snail baiting agent in the form of cylindrical pellets.

Test of the pH-value: Dried pellets are finely milled and stirred for 15 minutes in water as a 10% by weight suspension and left to sit for 1 minute. The pH-value of the aqueous phase amounts to 3.2.

### Application Example

### Example A:

### Control of Snails/Open Land

Test snails: Deroceras agreste
Test culture: Tagetes patula
Test method: Field test; Testing Center Höfchen, Bergian Land, Germany
Treatment day: May 27, 2002

Scattering of the baiting agent formulations according to example 1 with 5 g of formulation per m2 on 10 parcels of square-meter-size with 3 repetitions. The comparison standard Ferramol was likewise deployed with 5 g of product/m². The parcels were each planted with 10 Tagetes plants.

The evaluation takes place 3, 14 and 18 days after the application by determining the grub damage (% of plants with grub damage) on the test plants. Furthermore, possible phytotoxicity symptoms were evaluated.

The degree of effectiveness of the test substance amounts to 100% (according to Abbott), if no grub damage was observed and, as the case may be, it amounts to 0% if the grub damage is precisely as heavy as in the control.

| | | Dose | | | | Phytotoxicity |
|---|---|---|---|---|---|---|
| | Baiting | Product | Grub damage or Effect (%) | | | symptoms |
| No. | agent | g/m² | 7 DAT | 14 DAT | 18 DAT | 1-18 DAT |
| 1 | Control | | (3) | (11.7) | (21.8) | — |
| | (% grub | | | | | |
| | damage) | | | | | |
| 2 | according to | 5 | 57 | 63 | 62 | none |
| | Example 1: | | | | | |
| 4 | Ferramol* | 5 | 0 | 30 | 0 | none |
| | 1 RB | | | | | |

*Ferramol is a commercial product from the Nerdorff company; it contains iron and EDTA.

### Example B:

### Control of Snails/Open Land

Test snails: Arion hortensis
Test culture: Tagetes erecta and Lactuca sativa
Test method: Field test; Testing Center Höfchen, Bergian Land, Germany
Treatment day: Aug. 9, 2002

Scattering of the baiting agent formulations according to example 1 with 5 g of formulation per m² on 6 parcels of square-meter-size with 3 repetitions. The comparison standard Ferramol was likewise deployed with 5 g of product/m². The parcels were each planted with 10 Tagetes and lettuce plants.

The evaluation takes place 3, 5, 7 and 11 days after the application by determining the grub damage (% of plants with grub damage) on the test plants. The average of the grub damage to both plant species is described. Furthermore, possible phytotoxicity symptoms were evaluated.

The degree of effectiveness of the test substance amounts to 100% (according to Abbott), if no grub damage was observed and, as the case may be, it amounts to 0% if the grub damage is precisely as heavy as in the control.

| | | | | | | | | Phytotoxicity |
|---|---|---|---|---|---|---|---|---|
| | | Dose | Grub damage or Effect in % | | | | | symptoms |
| | | Product | 3 | 5 | 7 | 11 | 18 | 1-18 |
| Variant | Preparation | g/m² | DAT | DAT | DAT | DAT | DAT | DAT |
| 1 | Control | | (16) | (20) | (27) | (31) | (30) | — |
| | (% grub damage) | | | | | | | |
| | according to | 5 | 75 | 70 | 69 | 67 | 78 | none |
| | Example 1: | | | | | | | |
| 3 | Ferramol* 1 RB | 5 | 72 | 78 | 80 | 77 | 78 | none |

*Ferramol is a commercial product from the Nerdorff company; it contains iron and EDTA.

What is claimed is:

1-5. (canceled)

6. A composition comprising
(1) either
(a) a phosphonic acid ester of formula (I) 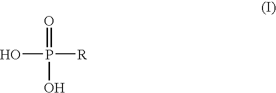
in which R represents C₁-C₁₀ alkyl that is equally or differently substituted once or more times by PO₃H₂, CO₂H, OH, NH₂, CN, halogen, C₁-C₈ alkylamine, or C₂-C₁₆ dialkylamine and that is optionally interrupted by 1 to 6 heteroatoms selected from the series consisting of N, O, S, and P with the proviso that the heteroatoms are not directly coupled to one another;
and one or more ammonium, alkaline metal, alkaline-earth metal, and/or iron salts; or
(b) an ammonium, alkaline metal, alkaline-earth metal, and/or iron salt of a phosphonic acid ester of formula (I),
(2) fine-grained cereal flour,
(3) optionally, a binding agent, and
(4) optionally, one or more additives.

7. A composition according to claim 6 wherein component (1) comprises one or more additional molluscicidal agents.

8. A method of preparing compositions according to claim 6 comprising
(1) preparing a premix comprising
(a) a phosphonic acid ester of formula (I) according to claim 6 and one or more ammonium, alkaline metal, alkaline-earth metal, and/or iron salts, or an ammonium, alkaline metal, alkaline-earth metal, and/or iron salt of a phosphonic acid esters of the formula (I) according to claim 6,
(b) at least one diluent, and
(c) optionally, one or more additives,
(2) mixing the resultant premix with
(a) fine-grained cereal flour,
(b) optionally, a binding agent, and
(c) optionally, one or more additives,
(3) optionally stirring the mixture from step (2) with a sufficient amount of water to form a homogeneous dough,
(4) extruding and reducing the mixture from step (2) or the dough from optional step (3) to small pieces, and
(5) drying the accumulated product form step (4).

9. A method of controlling terrestrial snails comprising allowing a composition according to claim 6 to act upon terrestrial snails and/or their habitat.
